(19) United States
(12) Patent Application Publication
(10) Pub. No.: US 2025/0305827 A1
(43) Pub. Date: Oct. 2, 2025

(54) METHOD AND SYSTEM FOR OPTIMIZING GYROSCOPE DELAY, AND DEVICE THEREOF

(71) Applicant: AAC Acoustic Technologies (Shanghai) Co., Ltd., Shanghai (CN)

(72) Inventors: Bang Hu, Shanghai (CN); Zheng Xiang, Shanghai (CN); Junsu Zhang, Shanghai (CN)

(21) Appl. No.: 18/749,665

(22) Filed: Jun. 21, 2024

Related U.S. Application Data
(63) Continuation of application No. PCT/CN2024/084189, filed on Mar. 27, 2024.

(51) Int. Cl. G01C 19/5776

(52) U.S. Cl. CPC G01C 19/5776

(57) ABSTRACT

The present disclosure provides a method and system, and a device. The method includes: acquiring first angular velocity data captured by a gyroscope sensor, wherein k is a positive integer; performing digital filtering on the angular velocity data to obtain second angular velocity data with a delay γ, and performing integration calculation on the second angular velocity data to obtain a first angular velocity scalar; acquiring an angular velocity vector of a predetermined length including the first angular velocity data captured by the gyroscope sensor, and successively performing Gaussian filtering and integration calculation on the angular velocity vector to obtain a second angular velocity scalar; and adding the first angular velocity scalar and the second angular velocity scalar to obtain optimized angular velocity data. Compared to the related art, in the present disclosure, the impacts caused by filter sampling are minimized, and zero-delay data output is achieved.

### CROSS REFERENCE TO RELATED APPLICATIONS

The present application is a continuation of PCT Patent Application No. PCT/CN2024/084189, entitled “METHOD AND SYSTEM FOR OPTIMIZING GYROSCOPE DELAY, AND DEVICE THEREOF,” filed Mar. 27, 2024, which is incorporated by reference herein in its entirety.

### TECHNICAL FIELD

The present disclosure relates to a data processing method, and in particular, relates to a method and system for optimizing gyroscope delay, and a device thereof.

### BACKGROUND

A gyroscope is an inertial detection device used to measure and control the angular motion of an object in a relative inertial space. In an optical image stabilizer (OIS), the gyroscope is used to capture a real-time jitter state of a current lens to obtain angular velocities in both pitch and yaw directions. In an OIS system, the angular velocity data obtained from the gyroscope is processed by a digital filter (often in the form of a simple IIR filter, such as a Butterworth filter), and only the frequency information that is of interest, or needed, by the developer or the corresponding hardware is retained.

In related arts, since a sampling frequency of the angular velocity data is much higher than a cutoff frequency of the digital filter (generally 30 Hz), an unnecessary delay is introduced to the signal, and the delay directly affects an anti-jitter effect of the OIS system.

Therefore, it is necessary to propose a method for optimizing a gyroscope delay to address the above problem.

### SUMMARY

The technical problem to be solved according to the present disclosure is to provide a method and system for optimizing a gyroscope delay and a device thereof, which are capable of reducing an unnecessary gyroscope delay caused by filter sampling.

In a first aspect, some embodiments of the present disclosure provide a method for optimizing a gyroscope delay. The method includes: S101, acquire first angular velocity data w(k) captured by a gyroscope sensor, wherein k is a positive integer. S102, perform digital filtering on the angular velocity data to obtain second angular velocity data w(k)′ with a delay γ, and performing integration calculation on the second angular velocity data w(k)′ to obtain a first angular velocity scalar. S103, acquire an angular velocity vector of a predetermined length including the first angular velocity data captured by the gyroscope sensor, and successively performing Gaussian filtering and integration calculation on the angular velocity vector to obtain a second angular velocity scalar. S104, add the first angular velocity scalar and the second angular velocity scalar to obtain optimized angular velocity data θ(k).

In some embodiments, in the case that the delay γ is an integer, the predetermined length is γ+1, and the angular velocity vector is [w(k−γ), . . . , w(k−1), w(k)].

In some embodiments, in the case that the delay γ is a non-integer, the delay γ is rounded up to obtain a constant n, the predetermined length is n+1, and the angular velocity vector is [w(k−n), . . . , w(k−1), w(k)].

In some embodiments, in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

In a second aspect, some embodiments of the present disclosure provide a system for optimizing a gyroscope delay. The system includes a data acquirer a first processor, a second processor, and an optimizer. The data acquirer is configured to acquire first angular velocity data w(k) captured by a gyroscope sensor, wherein k is a positive integer. The first processor is configured to perform digital filtering on the angular velocity data to obtain second angular velocity data w(k)′ with a delay γ, and perform integration calculation on the second angular velocity data w(k)′ to obtain a first angular velocity scalar. The second processor is configured to acquire an angular velocity vector of a predetermined length including the first angular velocity data captured by the gyroscope sensor, and successively perform Gaussian filtering and integration calculation on the angular velocity vector to obtain a second angular velocity scalar. The optimizer is configured to add the first angular velocity scalar and the second angular velocity scalar to obtain optimized angular velocity data θ(k).

In a third aspect, some embodiments of the present disclosure provide a computer device. The computer device includes: a memory, a processor, and a computer program stored in the memory and executable by the processor, causing when executed, the processor to implement operations in the method for optimizing the gyroscope delay as described above.

As an improvement, in the case that the delay γ is an integer, the predetermined length is γ+1, and the angular velocity vector is [w(k−γ), . . . , w(k−1), w(k)].

As an improvement, in the case that the delay γ is a non-integer, the delay γ is rounded up to obtain a constant n, the predetermined length is n+1, and the angular velocity vector is [w(k−n), . . . , w(k−1), w(k)].

As an improvement, in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

In a fourth aspect, some embodiments of the present disclosure provide non-transitory a computer-readable storage medium, storing a computer program therein. The computer program, when loaded and run by a processor, causes the processor to perform the method for optimizing the gyroscope delay as described above.

As an improvement, in the case that the delay γ is an integer, the predetermined length is γ+1, and the angular velocity vector is [w(k−γ), . . . , w(k−1), w(k)].

As an improvement, in the case that the delay γ is a non-integer, the delay γ is rounded up to obtain a constant n, the predetermined length is n+1, and the angular velocity vector is [w(k−n), . . . , w(k−1), w(k)].

As an improvement, in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

Compared to the related art, the method for optimizing the gyroscope delay according to the present disclosure includes: S101, acquire first angular velocity data w(k) captured by a gyroscope sensor, wherein k is a positive integer. S102, perform digital filtering on the angular velocity data to obtain second angular velocity data w(k)′ with a delay γ, and performing integration calculation on the second angular velocity data w(k)′ to obtain a first angular velocity scalar. S103, acquire an angular velocity vector of a predetermined length including the first angular velocity data captured by the gyroscope sensor, and successively performing Gaussian filtering and integration calculation on the angular velocity vector to obtain a second angular velocity scalar. S104, add the first angular velocity scalar and the second angular velocity scalar to obtain optimized angular velocity data θ(k). In the present disclosure, metadata is processed and scalar addition is performed according to the delay of filter sampling, and partitioned integration for non-integer delays is performed, such that the resulting gyroscope angular velocity data minimizes the impacts caused by filter sampling, and thus zero-delay data output is achieved.

### BRIEF DESCRIPTION OF THE DRAWINGS

For clearer descriptions of the technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a flowchart of a method for optimizing a gyroscope delay according to some embodiments of the present disclosure;

FIG. 2 is a schematic diagram of a comparison between waveforms of angular velocity data according to some embodiments of the present disclosure;

FIG. 3 is a schematic diagram of an enlarged comparison between waveforms of angular velocity data according to some embodiments of the present disclosure;

FIG. 4 is a schematic structural diagram of a system 200 for optimizing a gyroscope delay according to some embodiments of the present disclosure; and

FIG. 5 is a schematic structural diagram of a computer device according to some embodiments of the present disclosure.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

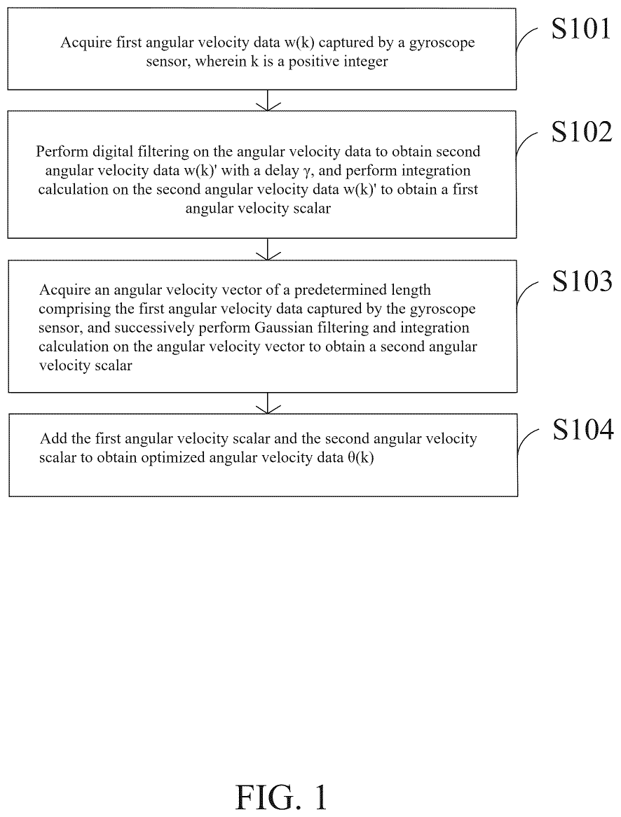

Referring to FIG. 1, FIG. 1 is a flowchart of a method for optimizing a gyroscope delay according to some embodiments of the present disclosure. The method includes the following steps.

In S101, first angular velocity data w(k) captured by a gyroscope sensor is acquired, wherein k is a positive integer.

In S102, digital filtering is performed on the angular velocity data to obtain second angular velocity data w(k)′ with a delay γ, and integration calculation is performed on the second angular velocity data w(k)′ to obtain a first angular velocity scalar.

In S103, an angular velocity vector of a predetermined length including the first angular velocity data captured by the gyroscope sensor is acquired, and Gaussian filtering and integration calculation are successively performed on the angular velocity vector to obtain a second angular velocity scalar.

In the embodiments of the present disclosure, whether the delay γ is an integer is discussed by example of two specific cases.

In the case that the delay γ is an integer, the predetermined length is γ+1, and the angular velocity vector is [w(k−γ), . . . , w(k−1), w(k)]. In this case, in S103, Gaussian filtering and integration calculation are performed based on the current angular velocity vector according to its sequence.

In the case that the delay γ is a non-integer, the delay γ is rounded up to obtain a constant n, and the predetermined length is n+1. For example, when the value of delay γ is 2.3, the value of constant n is 3 by rounding up the delay γ, and the angular velocity vector is [w(k−n), . . . , w(k−1), w(k)]. In this case, in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval. The predetermined ratio may be designed according to actual needs, with the purpose of keeping an integral range of the non-integer interval consistent with those of the rest of the integer intervals based on the predetermined ratio.

In S104, the first angular velocity scalar and the second angular velocity scalar are added to obtain optimized angular velocity data θ(k).

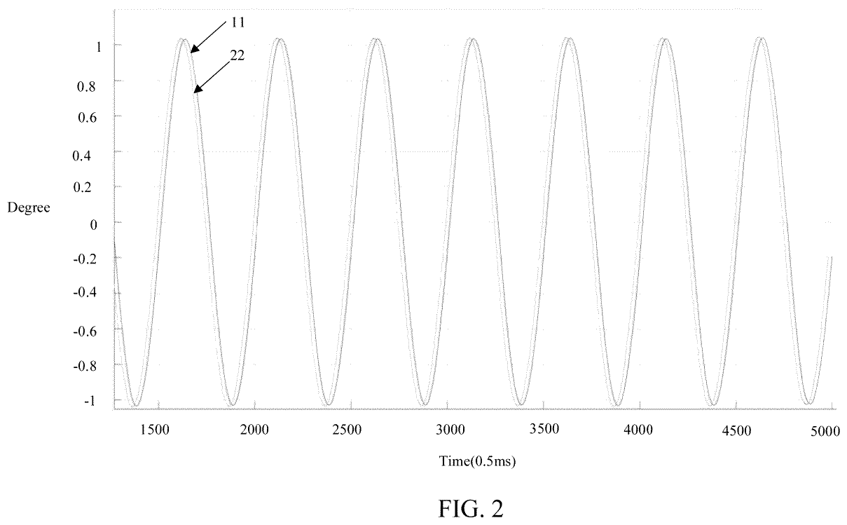

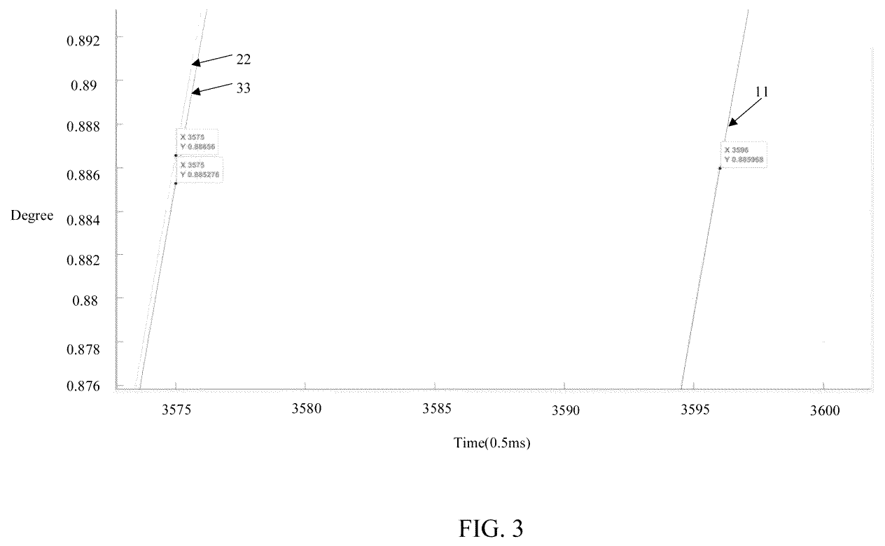

As illustrated in FIG. 2 and FIG. 3, FIG. 2 is a schematic diagram of a comparison of waveforms between the optimized angular velocity data θ(k) obtained by adding the first angular velocity scalar and the second angular velocity scalar (may be considered as data undergoing compensation), ideal zero-delay data, and data undergoing no compensation; and FIG. 3 illustrates an enlarged diagram of the waveform of FIG. 2. It can be seen that the optimized angular velocity data θ(k) experiencing compensation according to the embodiments of the present disclosure basically coincides with the ideal zero-delay data, whereas the data undergoing no compensation has a larger delay compared to the ideal zero-delay data. This proves the effectiveness of the method for optimizing the gyroscope delay according to the embodiments of the present disclosure. In FIG. 2 and FIG. 3, 11 represents the waveform of data undergoing no compensation (that is, with delay), 22 represents the waveform of ideal zero-delay data, and 33 represents the waveform of data undergoing compensation.

Compared to the related art, the method for optimizing the gyroscope delay according to the present disclosure includes: S101, acquire first angular velocity data w(k) captured by a gyroscope sensor, wherein k is a positive integer. S102, perform digital filtering on the angular velocity data to obtain second angular velocity data w(k)′ with a delay γ, and performing integration calculation on the second angular velocity data w(k)′ to obtain a first angular velocity scalar. S103, acquire an angular velocity vector of a predetermined length including the first angular velocity data captured by the gyroscope sensor, and successively performing Gaussian filtering and integration calculation on the angular velocity vector to obtain a second angular velocity scalar. S104, add the first angular velocity scalar and the second angular velocity scalar to obtain optimized angular velocity data θ(k). In the present disclosure, metadata is processed and scalar addition is performed according to the delay of filter sampling, and partitioned integration for non-integer delays is performed, such that the resulting gyroscope angular velocity data minimizes the impacts caused by filter sampling, and thus zero-delay data output is achieved.

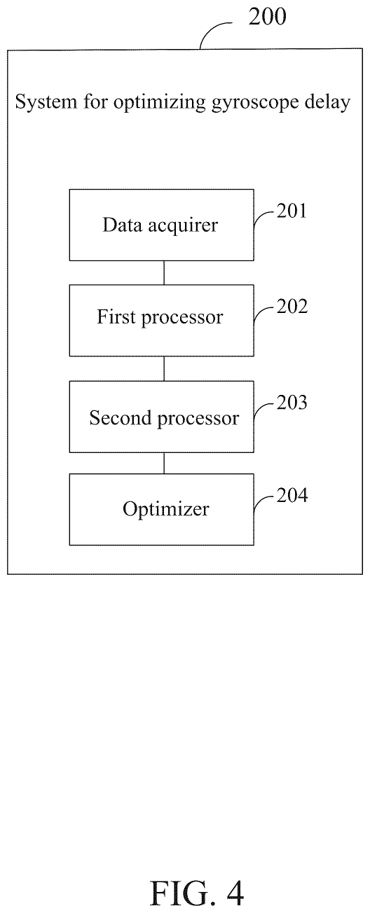

Some embodiments of the present disclosure further provide a system. Referring to FIG. 4, FIG. 4 is a schematic structural diagram of a system 200 for optimizing a gyroscope delay according to some embodiments of the present disclosure. The system 200 includes a data acquirer 201, a first processor 202, a second processor 203, and an optimizer 204.

The data acquirer 201 is configured to acquire first angular velocity data w(k) captured by a gyroscope sensor, wherein k is a positive integer.

The first processor 202 is configured to perform digital filtering on the angular velocity data to obtain second angular velocity data w(k)′ with a delay γ, and perform integration calculation on the second angular velocity data w(k)′ to obtain a first angular velocity scalar.

The second processor 203 is configured to acquire an angular velocity vector of a predetermined length including the first angular velocity data captured by the gyroscope sensor, and successively perform Gaussian filtering and integration calculation on the angular velocity vector to obtain a second angular velocity scalar.

The optimizer 204 is configured to add the first angular velocity scalar and the second angular velocity scalar to obtain optimized angular velocity data θ(k).

The system 200 for optimizing the gyroscope delay is capable of performing the steps in the method for optimizing the gyroscope delay as described in the above embodiments, and is capable of achieving the same technical effects as described in the above embodiments, which are not described herein any further.

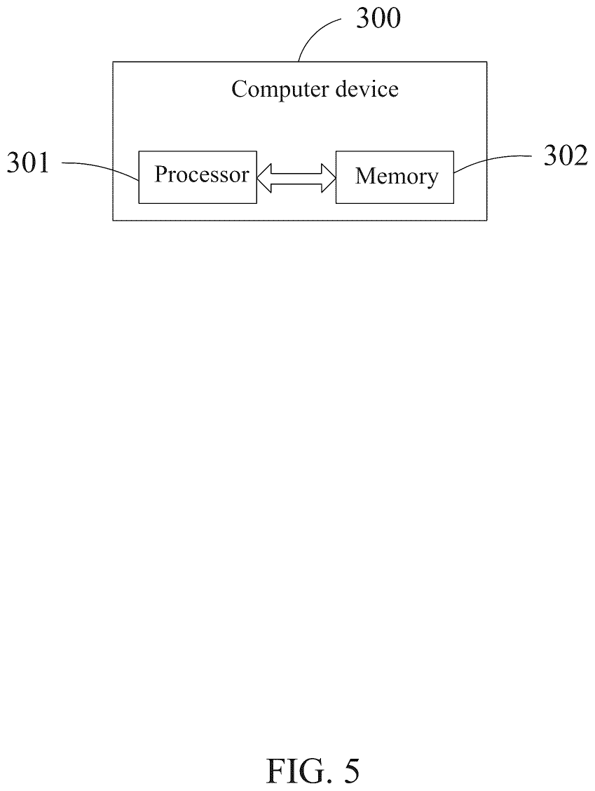

Some embodiments of the present disclosure also provide a computer device. Referring to FIG. 5, FIG. 5 is a schematic structural diagram of a computer device 300 according to some embodiments of the present disclosure. The computer device 300 includes a memory 302, a processor 301, and a computer program stored in the memory 302 that is runnable on the processor 301.

The processor 301 calls the computer program stored in the memory 302 to implement operations in the method according to some embodiments of the present disclosure, referring to FIG. 1, specifically including the following operations.

In S101, first angular velocity data w(k) captured by a gyroscope sensor is acquired, wherein k is a positive integer.

In S102, digital filtering is performed on the angular velocity data to obtain second angular velocity data w(k)′ with a delay γ, and integration calculation is performed on the second angular velocity data w(k)′ to obtain a first angular velocity scalar.

In S103, an angular velocity vector of a predetermined length including the first angular velocity data captured by the gyroscope sensor is acquired, and Gaussian filtering and integration calculation are successively performed on the angular velocity vector to obtain a second angular velocity scalar.

In the case that the delay γ is an integer, the predetermined length is γ+1, and the angular velocity vector is [w(k−γ), . . . , w(k−1), w(k)].

In the case that the delay γ is a non-integer, the delay γ is rounded up to obtain a constant n, the predetermined length is n+1, and the angular velocity vector is [w(k−n), . . . , w(k−1), w(k)].

In S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

In S104, the first angular velocity scalar and the second angular velocity scalar are added to obtain optimized angular velocity data θ(k).

The computer device 300 according to the embodiments of the present disclosure is capable of performing the steps in the method for optimizing the gyroscope delay as described in the above embodiments, and is capable of achieving the same technical effects as described in the above embodiments, which are not described herein any further.

Some embodiments of the present disclosure further provide a non-transitory computer-readable storage medium, storing a computer program therein. The computer program, when loaded and executed by a processor, causes the processor to implement operations in the method for optimizing the gyroscope delay as described in the above embodiments, and achieve the same technical effects as described in the above embodiments, which are not described herein any further.

Persons of ordinary skill in the art may understand that all or part of the steps of the methods in the embodiments may be implemented by a program instructing relevant hardware. The program may be stored in a computer-readable storage medium. When the program runs, the steps of the methods in the embodiments are performed. The storage medium may be any medium capable of storing program codes, such as a magnetic disk, a compact disc read-only memory (CD-ROM), a read-only memory (ROM), or a random-access memory (RAM).

It should be noted that, in this specification, terms “comprises,” “include,” “contain,” and any other variations thereof are intended to cover a non-exclusive inclusion, such that a process, method, article, or apparatus, that comprises, has, includes, or contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus.

Through the above description of the method embodiments, it is clear to persons skilled in the art that the methods according to the above embodiment may be accomplished by software plus necessary universal hardware platforms, and definitely may also be accomplished by hardware, but in many cases, the software implementation is preferred. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (which may be a mobile phone, a personal computer, a server, an air conditioner, a network device or the like) to perform the methods according to various embodiments of the present disclosure.

The embodiments of the present disclosure are described above in conjunction with the accompanying drawings, which are merely exemplary ones for illustrating the present disclosure. However, the present disclosure is not limited to the specific embodiments as described above, and the specific embodiments are merely illustrative rather than limitative. Persons of ordinary skill in the art may make modifications or equivalent variations within the scope of the disclosure without departing from the spirit and scope of the present disclosure and the claims, all of which are subject to the protection of the present disclosure.

1. A method for optimizing a gyroscope delay, comprising:
S101, acquiring first angular velocity data w(k) captured by a gyroscope sensor, wherein k is a positive integer;
S102, performing digital filtering on the angular velocity data to obtain second angular velocity data w(k)′ with a delay γ, and performing integration calculation on the second angular velocity data w(k)′ to obtain a first angular velocity scalar;
S103, acquiring an angular velocity vector of a predetermined length comprising the first angular velocity data captured by the gyroscope sensor, and successively performing Gaussian filtering and integration calculation on the angular velocity vector to obtain a second angular velocity scalar; and
S104, adding the first angular velocity scalar and the second angular velocity scalar to obtain optimized angular velocity data θ(k).

2. The method according to claim 1, wherein in a case that the delay γ is an integer, the predetermined length is γ+1, and the angular velocity vector is [w(k−γ), . . . , w(k−1), w(k)].

3. The method according to claim 1, wherein in a case that the delay γ is a non-integer, the delay γ is rounded up to obtain a constant n, the predetermined length is n+1, and the angular velocity vector is [w(k−n), . . . , w(k−1), w(k)].

4. The method according to claim 3, wherein in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

5. A system for optimizing a gyroscope delay, comprising:
a data acquirer, configured to acquire first angular velocity data w(k) captured by a gyroscope sensor, wherein k is a positive integer;
a first processor, configured to perform digital filtering on the angular velocity data to obtain second angular velocity data w(k)′ with a delay γ, and perform integration calculation on the second angular velocity data w(k)′ to obtain a first angular velocity scalar;
a second processor, configured to acquire an angular velocity vector of a predetermined length comprising the first angular velocity data captured by the gyroscope sensor, and successively perform Gaussian filtering and integration calculation on the angular velocity vector to obtain a second angular velocity scalar; and
an optimizer, configured to add the first angular velocity scalar and the second angular velocity scalar to obtain optimized angular velocity data θ(k).

6. A computer device, comprising: a memory, a processor, and a computer program stored in the memory and executable by the processor, causing when executed, the processor to implement operations in the method for optimizing the gyroscope delay according to claim 1.

7. The computer device according to claim 6, wherein in a case that the delay γ is an integer, the predetermined length is γ+1, and the angular velocity vector is [w(k−γ), . . . , w(k−1), w(k)].

8. The computer device according to claim 6, wherein in a case that the delay γ is a non-integer, the delay γ is rounded up to obtain a constant n, the predetermined length is n+1, and the angular velocity vector is [w(k−n), . . . , w(k−1), w(k)].

9. The computer device according to claim 8, wherein in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.

10. A non-transitory computer-readable storage medium, storing a computer program therein, wherein the computer program, when loaded and run by a processor, causes the processor to perform the method for optimizing the gyroscope delay as defined in any one of claim 1.

11. The non-transitory computer-readable storage medium according to claim 10, wherein in a case that the delay γ is an integer, the predetermined length is γ+1, and the angular velocity vector is [w(k−γ), . . . , w(k−1), w(k)].

12. The non-transitory computer-readable storage medium according to claim 10, wherein in a case that the delay γ is a non-integer, the delay γ is rounded up to obtain a constant n, the predetermined length is n+1, and the angular velocity vector is [w(k−n), . . . , w(k−1), w(k)].

13. The non-transitory computer-readable storage medium according to claim 12, wherein in S103, based on the constant n and the delay γ, the angular velocity vector with [w(k−n), . . . , w(k−1), w(k)] is divided into integer and non-integer intervals, and during integration calculation, an integral of a first integer interval in the angular velocity vector is multiplied by a predetermined ratio to obtain an integral of a first non-integer interval.
